(19) United States
(12) Patent Application Publication
(10) Pub. No.: US 2026/0338341 A1
(43) Pub. Date: Oct. 29, 2026

(54) HEADLIGHT FOR A MOTOR VEHICLE

(71) Applicant: HELLA GMBH & CO. KGAA, Lippstadt (DE)

(72) Inventors: Carmen Bungenstock, Kleinenberg (DE); Gerhard Kloos, Erwitte (DE); Philip Stroop, Schloß Holte-Stukenbrock (DE); Benjamin Willeke, Paderborn (DE)

(21) Appl. No.: 19/110,952

(22) PCT Filed: Sep. 11, 2023
(86) PCT No.: PCT/EP2023/074879

§ 371 Date: Mar. 12, 2025

(30) Foreign Application Priority Data
Sep. 20, 2022 (DE) 10 2022 124 019.3

(51) Int. Cl. F21S 41/275; F21S 41/255; F21W 102/135; F21W 102/20; G02B 3/08

(52) U.S. Cl. CPC F21S 41/275; F21S 41/255; G02B 3/08; F21S 2243/00; F21W 2102/135; F21W 2102/20

(57) ABSTRACT

The invention relates to a headlight for a motor vehicle. The headlight includes at least one light source and an optical system with a plurality of optical components to shape the light emitted by the at least one light source and to project it into the space outside of the motor vehicle in such a way that a dipped beam distribution of the headlight which has a light-dark boundary is produced. The headlight also includes at least one refractive structure which is arranged on at least one of the optical components and has a plurality of structural elements, the at least one structure being set up to influence the gradient of the light intensity of the dipped beam light distribution in the region of the light-dark boundary, the structural elements of the at least one refractive structure having a width of between 0.5 mm and 1.0 mm.

### CROSS-REFERENCE TO RELATED APPLICATIONS

This application is the National Stage of International Application No. PCT/EP2023/074879 filed on Sep. 11, 2023, which claims priority to and all advantages of German Patent Application No. 10 2022 124 019.3 filed on Sep. 20, 2022, the disclosures of which are hereby incorporated by reference in their entirety.

### BACKGROUND

The present invention relates to a headlight for a motor vehicle and a method of manufacturing an optical component of the headlight.

In the case of lighting devices designed as headlights for a motor vehicle, edges can be provided in the light distribution projected into the space outside of the vehicle. These can be, for example, the light-dark boundary of a dipped beam distribution or vertical edges of a matrix high beam. When reproducing the light-dark boundary (HDG) in the space outside of the motor vehicle, the gradient of light intensity in the region of the light-dark boundary must be of a prescribed order of magnitude in accordance with a legal regulation known as AK-31. This corresponds to the local softening of the light-dark boundary of the dipped beam distribution at a horizontal angle of −2.5°. The technical difficulty lies in the fact that the light-dark boundary for other horizontal angles must not be softened, or only to a barely noticeable extent. In particular, at a horizontal angle of 0°, glare values must not be exceeded in order to avoid impairing oncoming traffic. Another conflicting technical requirement is that the active values of the headlight, such as the maximum intensity, may only be lowered very slightly. However, a softening of the light-dark boundary is usually accompanied by a reduction in these values.

A headlight of the aforementioned type is known from DE 10 2018 131 556 A1. In the headlight described therein, a projection lens of the headlight is to be provided with a microstructure. This microstructure serves to locally soften the light-dark boundary. Structural elements of this microstructure each have a width of significantly less than 100 μm. The implementation of such a microscopic structure in an industrial series process entails difficulties with regard to the molding of the microscopically small structures, involves risks with regard to repeatability and increases the degree of complexity of series production. Furthermore, the insertion of the microstructure represents an additional process step.

### SUMMARY

The problem underlying the present invention is the creation of a headlight of the type mentioned at the beginning, which can be manufactured more easily and at lower cost. Furthermore, a method for manufacturing an optical component of the headlight is to be specified.

According to the invention, this is achieved by a headlight of the type mentioned at the beginning with the features set forth herein and by a method of the type mentioned at the beginning with the features set forth herein.

According to one embodiment, it is provided that the structural elements of the at least one refractive structure have a width of between 0.5 mm and 1.0 mm. In particular, the height of the structural elements can be between 0.1 mm and 1.0 mm, preferably between 0.3 mm and 0.7 mm, for example around 0.5 mm. In contrast to the prior art, the refractive structure is therefore not a microscopic but a macroscopic refractive structure. A macroscopic structure is easier to specify, easier to pass on to the component manufacturer in terms of data technology and, in particular, much easier to manufacture. Due to the selected mechanical dimensions of the structural elements, no diffractive effects or only very small diffractive effects occur on the refractive structure. This allows the effect of the optical component to be fully determined and predicted using ray optics. Color effects due to wave-optical phenomena, which can occur on very small structures, are at least reduced or even completely eliminated.

It may be provided that at least one of the structural elements is annular or partially annular, in particular that several, preferably all, of the structural elements of the refractive structure are annular or partially annular. Like a Fresnel lens, the structural elements can thus deflect parts of the light passing through them in a desired direction.

It is possible for the annular or partially annular structural elements to be arranged coaxially or concentrically to one another. It may be provided that a first of the annular or partially annular structural elements has a smaller diameter than a second of the annular or partially annular structural elements.

It is possible that at least one of the structural elements is designed partially annular in a manner such that it extends over less than 360° in the circumferential direction, in particular extends only over one sector of a circle. As a result, only a smaller part of the optical component on which the refractive structure is arranged is modified, such that the optical component can fulfill its actual function more effectively.

It may be provided that at least one of the optical components is designed as a lens, in particular as an aspherical lens, with the refractive structure being integrated into the lens.

Alternatively, it may be provided that at least one of the optical components is designed as a lens having a Fresnel structure, with the refractive structure being integrated into the Fresnel structure. The Fresnel structure may comprise annular steps each having a useful flank and an interference flank, the useful flank being that region of the step which is set up for light to pass through it, and the interference flank being that region of the step which is not set up for light to pass through it, with the useful flanks of the Fresnel structure including a plane perpendicular to the optical axis of the lens at an angle of incidence which may, for example, have a value between 0.1° and 5.0°.

It is possible that the integration of the refractive structure into the Fresnel structure leads to a partial change in the angle of incidence of the useful flanks of the Fresnel structure, in particular wherein the angles of incidence of the interference flanks of the Fresnel structure are not changed by the integration of the refractive structure into the Fresnel structure. By slightly changing the angle of incidence of some of the useful flanks, the diacaustic can be suitably widened by light rays that pass through the optical component provided with the structure in a solid angle range around the light-dark boundary in order to suitably soften the light-dark boundary.

It may be provided that the headlight comprises a primary optical system and a secondary optical system, in particular wherein the primary optical system is set up to shape the light emitted by the at least one light source in such a manner that an extended light distribution is produced, and wherein the secondary optical system is set up to convert the extended light distribution produced by the primary optical system into a light distribution corresponding to the dipped beam distribution of the headlight. The secondary optical system can have a projection lens.

It is possible that the refractive structure is arranged on the projection lens of the secondary optical system. The refractive structure can be integrated into the coupling side or the decoupling side of the projection lens of the secondary optical system.

According to another embodiment, it is provided that the optical component is manufactured from plastic by injection molding, wherein the refractive structure is also produced during the injection molding. This eliminates the need for additional work steps to insert the refractive structure into the optical component.

It may be provided that design data of the optical component to be manufactured are used for injection molding, which are generated in an iterative procedure with regard to the shape and the arrangement of the structural elements of the refractive structure, in particular wherein in an iteration step in the design data the shape and/or the arrangement of at least one of the structural elements is changed and wherein in a subsequent iteration step it is determined in a simulation whether an optical component manufactured in accordance with these design data fulfills the legal requirements for the dipped beam distribution, in particular in the region of the light-dark boundary. In doing so, an attempt can be made to minimize both the effect of the refractive structure in the solid angle range under consideration and its geometric proportion on the surface of the optical component. In particular, this iterative procedure ultimately leads to the specification of a softening function for the discrete angles of incidence of the useful flanks of the refractive structure, which achieves the desired result. This softening function can be realized as a refractive structure and implemented in the optical component.

### BRIEF DESCRIPTION OF THE DRAWINGS

The invention is explained in more detail below with reference to the accompanying drawings. In the figures:

FIG. 1 is a schematic side view of a headlight according to the invention with light rays drawn as examples;

FIG. 2 is a perspective view of a first embodiment of a projection lens of the headlight according to FIG. 1, wherein the projection lens is provided with a Fresnel structure;

FIG. 3 is a view of the projection lens according to FIG. 2 corresponding to FIG. 2, in which the regions provided with refractive structure are indicated;

FIG. 4 is a perspective view of a second embodiment of a projection lens of a headlight according to the invention, wherein the projection lens is provided with a Fresnel structure;

FIG. 5a is a schematic section through a part of the Fresnel structure of the projection lens according to FIG. 2, in which no refractive structure for softening the light-dark boundary is integrated;

FIG. 5b is a schematic section through a part of the Fresnel structure of the projection lens according to FIG. 3, in which a refractive structure for softening the light-dark boundary is integrated;

FIG. 6 is a perspective view of a projection lens of a headlight according to the state of the art;

FIG. 7 is a perspective view of a third embodiment of a projection lens of a headlight according to the invention;

FIG. 8a is a light distribution produced by a headlight that has no refractive structure for softening the light-dark boundary;

FIG. 8b is a graph illustrating the change in luminous intensity of the light distribution according to FIG. 8a in the vertical direction in the region of the light-dark boundary;

FIG. 9a is a light distribution produced by the headlight according to FIG. 1; and

FIG. 9b is a graph illustrating the change in luminous intensity of the light distribution according to FIG. 9a in the vertical direction in the region of the light-dark boundary.

In the figures, identical and functionally identical parts are provided with the same reference signs.

### DETAILED DESCRIPTION

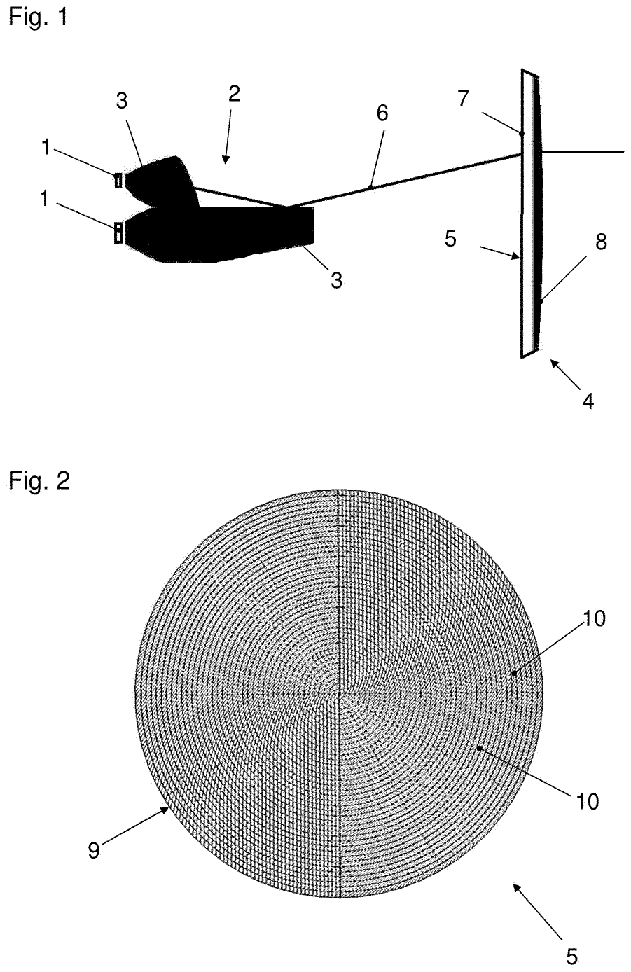

The exemplary embodiment of a headlight according to the invention shown in FIG. 1 comprises two light sources 1, shown only schematically, a primary optical system 2, which has two interconnected optical components 3, and a secondary optical system 4, which in particular has only one optical component designed as a projection lens 5. It is entirely possible for the primary optical 2 to consist of only one component 3 or more than two components 3. It is also possible for the secondary optical system 4 to consist of more than one component.

The primary optical system 2 is set up to shape the light 6 emitted by the light sources 1 in such a manner that an extended light distribution is produced. Furthermore, the secondary optical system 4 is set up to convert the extended light distribution produced by the primary optical system 2 into a light distribution corresponding to the dipped beam distribution of the headlight, which has a light-dark boundary.

The projection lens 5 has a coupling side 7 for the light 6 emitted by the primary optical system 2 and a decoupling side 8 from which the light 6 can emerge. The projection lens 5 is designed as a lens having a Fresnel structure 9, wherein the Fresnel structure 9 is arranged on the decoupling side 8 of the projection lens 5 (see FIG. 1 and FIG. 2).

In the exemplary embodiment shown in FIG. 1 to FIG. 3, the coupling side 7 is flat. FIG. 4 shows an alternative embodiment of the projection lens 5, in which the Fresnel structure 9 is arranged on a curved substrate.

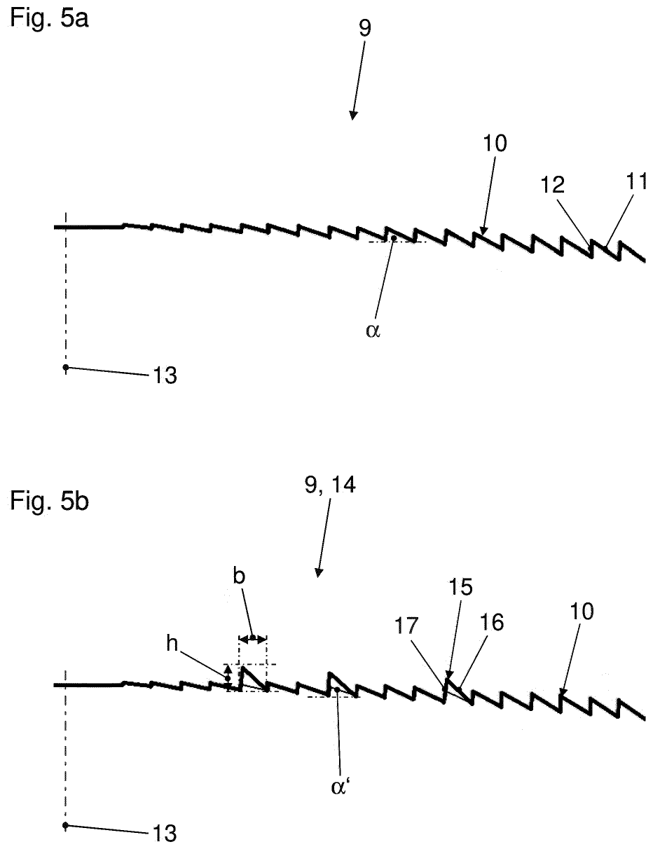

The Fresnel structure 9 comprises annular steps 10, each of which has a useful flank 11 and an interference flank 12 (see FIG. 5a). The useful flank 11 is the region of the step 10 that is designed to allow light to pass through it, and the interference flank 12 is the region of the step 10 that is not designed to allow light to pass through it. The useful flanks 11 of the Fresnel structure 9 include a plane perpendicular to the optical axis 13 of the lens at an angle of incidence a which may, for example, have a value between 0.1° and 5.0° (see FIG. 5a).

In the illustrated exemplary embodiment, the height of the annular steps 10 increases from the center of the projection lens 5 in a radial direction towards the outside. This can be seen in FIG. 5a, which shows a radial section through the Fresnel structure 9, with the left end of FIG. 5a corresponding to the center of the projection lens 5 and the right end of FIG. 5a corresponding to the edge of the projection lens 5. It is entirely possible that the height of the steps 10 does not change in a radial direction or changes in some other manner.

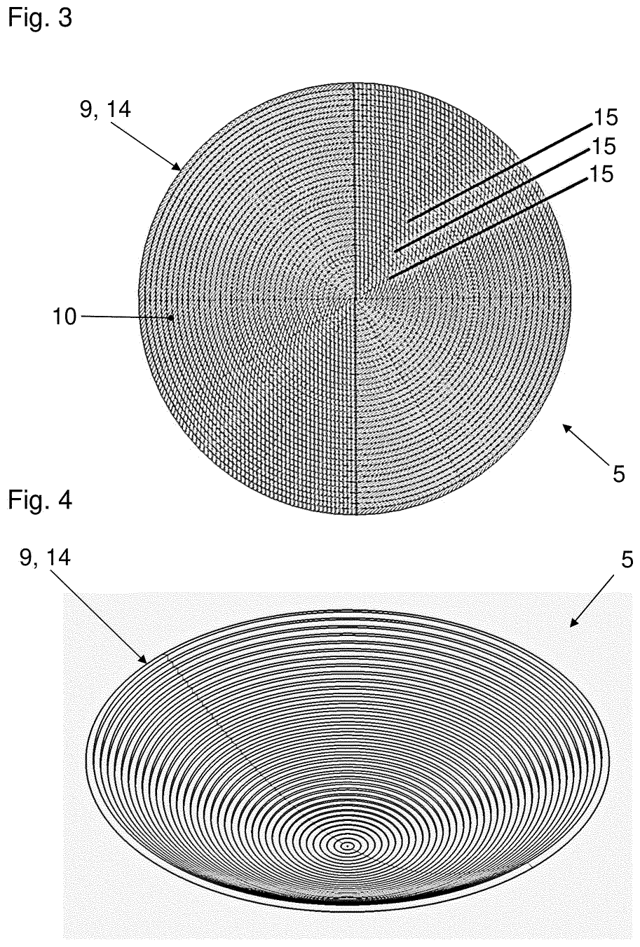

To soften the light-dark boundary, a refractive structure 14 is also provided, which is integrated into the Fresnel structure 9 at least in sections. Corresponding to the steps 10 of the Fresnel structure 9, the refractive structure 14 has structural elements 15 that are annular or partially annular (see FIG. 3). The structural elements 15 of the refractive structure 14 can have a width b in the radial direction of the projection lens of between 0.5 mm and 1.0 mm (see FIG. 5b). The height h of the structural elements can in particular be between 0.1 mm and 1.0 mm, preferably between 0.3 mm and 0.7 mm, for example around 0.5 mm.

In the exemplary embodiment according to FIG. 2 and FIG. 3, the refractive structure 14 is only integrated into the Fresnel structure 9 in individual regions. In these regions, at least segments of individual annular steps of the 10 Fresnel structure 9 are replaced by annular or partially annular structural elements 15 of the refractive structure 14 (see FIG. 3).

As with the Fresnel structure 9, the structural elements 15 of the refractive structure 14 each have a useful flank 16 and an interference flank 17 (see FIG. 4b and FIG. 5b). In the illustrated exemplary embodiment, the interference flank 17 of the refractive structure 14 is slightly longer than the interference flank 12 of the Fresnel structure 9. However, the angle of incidence of the interference flank 17 of the refractive structure 14 is the same as the angle of incidence of the interference flank 12 of the Fresnel structure 9.

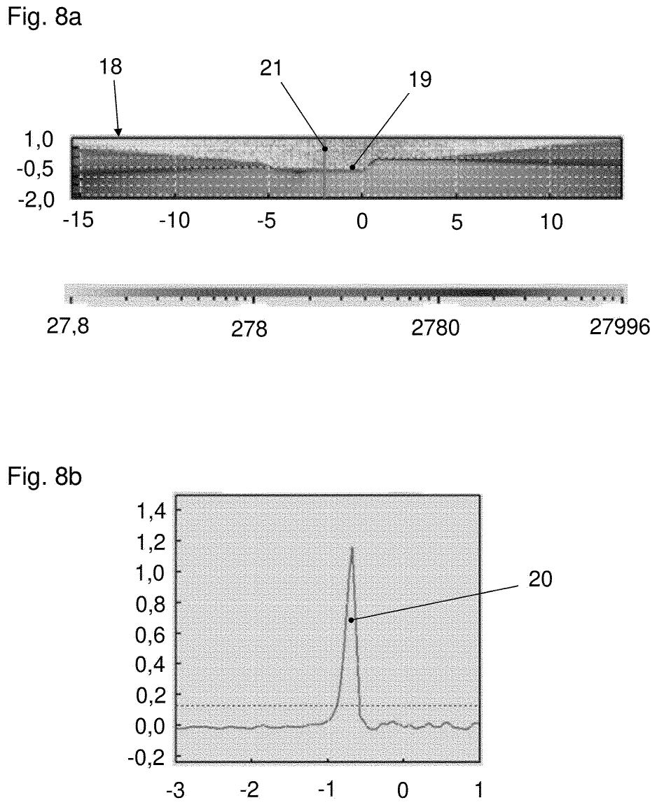

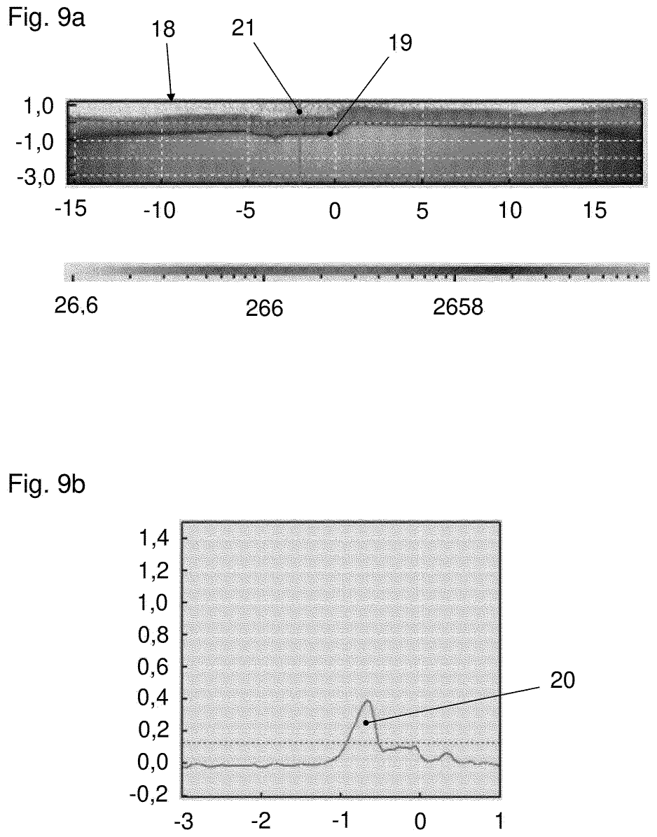

The angle of incidence α′ of the useful flank 16 of the refractive structure 14 is not equal to the angle of incidence a of the useful flank 11 of the Fresnel structure 9. In particular, the angle of incidence α′ of the useful flank 16 of the refractive structure 14 is greater than the angle of incidence α of the useful flank 11 of the Fresnel structure 9. Due to the changed angle of incidence α′ of the useful flank 16 of the refractive structure 14, the diacaustic can be suitably widened by light rays that pass through the projection lens 5 in a solid angle range around the light-dark boundary in order to soften the light-dark boundary. This is illustrated as an example in FIG. 8a to FIG. 9b.

FIG. 8a shows a dipped beam distribution 18 produced by a projection lens 5 having a Fresnel structure 9 without an integrated refractive structure 14. This dipped beam distribution 18 has a light-dark boundary 19. The change 20 in the luminous intensity of this dipped beam light distribution 18 in the vertical direction along the line 21 is illustrated in FIG. 8b. It can be seen that the change 20 is comparatively large, such that there is a very hard transition between the illuminated solid angle located below the light-dark boundary 19 and the non-illuminated solid angle located above the light-dark boundary 19. The gradient of the light intensity of the dipped beam distribution 18 in the region of the light-dark boundary 19 is therefore very large.

FIG. 9a shows a dipped beam distribution 22 produced by a projection lens 5 having a refractive structure 14 integrated into the Fresnel structure 9. This dipped beam distribution 22 also has a light-dark boundary 19. The change 20 in the luminous intensity of this dipped beam distribution 22 in the vertical direction along the line 21 is illustrated in FIG. 9b. It can be seen that the change 20 is comparatively small, so that there is a smooth transition between the illuminated solid angle located below the light-dark boundary 19 and the non-illuminated solid angle located above the light-dark boundary 19. The gradient of the light intensity of the dipped beam distribution 22 in the region of the light-dark boundary 22 is therefore comparatively small.

It is entirely possible that the refractive structure 14 is not arranged on the decoupling side 8 of the projection lens 5, but on the coupling side 7 of the projection lens 5.

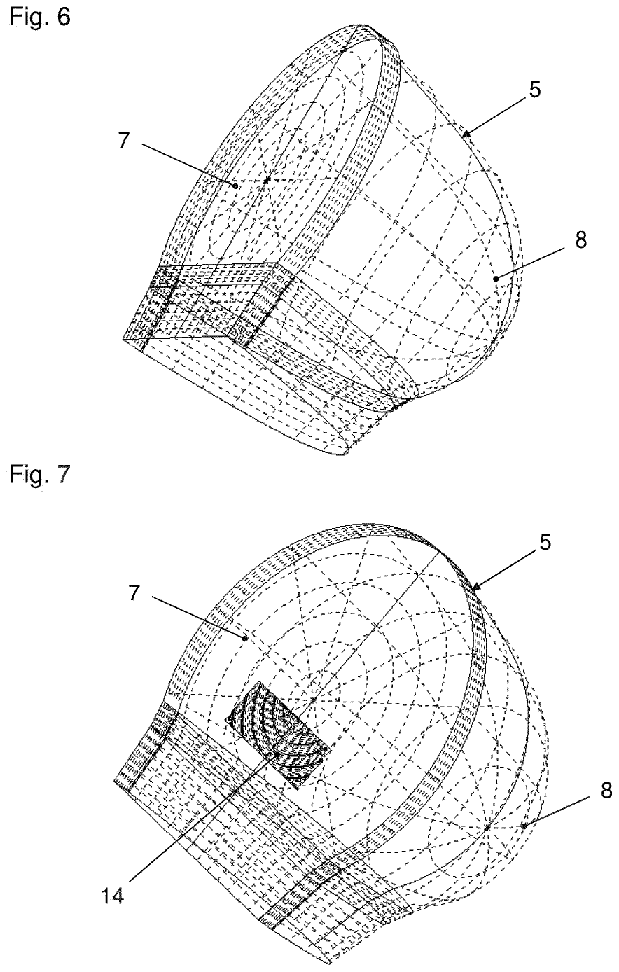

FIG. 6 shows a projection lens 5 that does not have a Fresnel structure, but is designed as a lens, in particular as a plano-convex aspherical lens.

FIG. 7 shows a projection lens 5 that is similar in shape to the lens according to FIG. 6. However, a refractive structure 14 is integrated into the projection lens 5, which is set up to influence the light passing through the projection lens 5 in such a way that the light-dark boundary is softened. The refractive structure 14 may be similar or identical to the structure 14 of the exemplary embodiments according to FIG. 2 to FIG. 5b. In particular, the structure 14 has structural elements 15, at least one of which is annular or partially annular.

In the exemplary embodiment according to FIG. 7, the refractive structure 14 is arranged on the, in particular flat, coupling side 7 of the projection lens 5. It is entirely possible that the refractive structure 14 is arranged on the, in particular convex, decoupling side 8 of the projection lens 5.

### LIST OF REFERENCE SIGNS

1 light source
2 primary optical system
3 optical component of the primary optical system
4 secondary optical system
5 projection lens of the secondary optical system
6 light emitted by the light source
7 coupling side of the projection lens
8 decoupling side of the projection lens
9 Fresnel structure of the projection lens
10 annular step of the Fresnel structure
11 useful flank of the Fresnel structure
12 interference flank of the Fresnel structure
13 optical axis of the lens formed by the Fresnel structure
14 refractive structure for softening the light-dark boundary
15 structural element of the refractive structure
16 useful flank of the refractive structure
17 interference flank of the refractive structure
18 dipped beam distribution produced by a projection lens having Fresnel structure without integrated refractive structure
19 light-dark boundary of the dipped beam distribution
20 change in the luminous intensity of the dipped beam distribution
21 line in the vertical direction of the dipped beam distribution
22 dipped beam distribution produced by a projection lens having a refractive structure integrated into the Fresnel structure
b width of a structural element of the refractive structure in radial direction
h height of a structural element of the refractive structure
α angle of incidence of the useful flank of the Fresnel structure
α′ angle of incidence of the useful flank of the refractive structure

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A headlight for a motor vehicle, comprising
at least one light source;
an optical system with a plurality of optical components, which is configured to shape the light emitted by the at least one light source and to project it into the space outside of the motor vehicle in such a manner that a dipped beam distribution of the headlight which has a light-dark boundary is produced; and
at least one refractive structure which is arranged on at least one of the optical components and has a plurality of structural elements, the at least one structure being configured to influence the gradient of the light intensity of the dipped beam light distribution in the region of the light-dark boundary, wherein the structural elements of the at least one refractive structure have a width of between 0.5 mm and 1.0 mm.

2. The headlight according to claim 1, wherein at least one of the structural elements is annular or partially annular.

3. The headlight according to claim 2, wherein the annular or partially annular structural elements are arranged coaxially or concentrically to one another.

4. The headlight according to claim 2, wherein a first of the annular or partially annular structural elements has a smaller diameter than a second of the annular or partially annular structural elements.

5. The headlight according to claim 2, wherein at least one of the structural elements is designed partially annular in a manner such that it extends over less than 360° in the circumferential direction over a sector of a circle.

6. The headlight according to claim 1, wherein at least one of the optical components is designed as an aspherical lens, the refractive structure being integrated into the aspherical lens.

7. The headlight according to claim 1, wherein at least one of the optical components is designed as a lens having a Fresnel structure, the refractive structure being integrated into the Fresnel structure.

8. The headlight according to claim 7, wherein the Fresnel structure comprises annular steps, each of which has a useful flank and an interference flank, the useful flank being that region of the step which is set up for light to pass through it, and the interference flank being that region of the step which is not set up for light to pass through it, with the useful flanks of the Fresnel structure including a plane perpendicular to the optical axis of the lens at an angle of incidence having a value between 0.1° and 5.0°.

9. The headlight according to claim 8, wherein the integration of the refractive structure into the Fresnel structure leads to a partial change in the angles of incidence of the useful flanks of the Fresnel structure, and wherein the angles of incidence of the interference flanks of the Fresnel structure are not changed by the integration of the refractive structure into the Fresnel structure.

10. The headlight according to claim 1, wherein the headlight comprises a primary optical system and a secondary optical system, wherein the primary optical system is configured to shape the light emitted by the at least one light source in such a way that an extended light distribution is produced, and wherein the secondary optical system is configured to convert the extended light distribution produced by the primary optical system into a light distribution corresponding to the dipped light distribution of the headlight.

11. The headlight according to claim 10, wherein the secondary optical system has a projection lens.

12. The headlight according to claim 11, wherein the refractive structure is arranged on the projection lens of the secondary optical system.

13. The headlight according to claim 12, wherein the refractive structure is integrated into the coupling side or the decoupling side of the projection lens of the secondary optical system.

14. A method of manufacturing an optical component for the headlight according to claim 1, wherein the refractive structure is arranged on the optical component and is configured to influence the gradient of the light intensity of the dipped beam distribution in the region of the light-dark boundary, wherein the optical component is manufactured from plastic by injection molding, wherein the refractive structure is also produced during the injection molding.

15. The method according to claim 14, wherein design data of the optical component to be manufactured are used for injection molding, which design data are generated in an iterative procedure with regard to the shape and the arrangement of the structural elements of the refractive structure, wherein in an iteration step in the design data the shape or the arrangement of at least one of the structural elements is changed and wherein in a subsequent iteration step it is determined in a simulation whether an optical component manufactured in accordance with these design data fulfills the legal requirements for the dipped beam distribution in the region of the light-dark boundary.
